(19) United States
(12) Patent Application Publication
(10) Pub. No.: US 2011/0040537 A1
(43) Pub. Date: Feb. 17, 2011

(54) SIMULATION FOR A MULTI-DIMENSIONAL ANALYTICAL SYSTEM

(75) Inventor: Jenngang Shih, Concord, CA (US)

Correspondence Address: BLAKELY SOKOLOFF TAYLOR & ZAFMAN LLP, 1279 OAKMEAD PARKWAY, SUNNYVALE, CA, 94085-4040, US

(73) Assignee: SAP AG, Waldorf (DE)

(21) Appl. No.: 12/542,559

(22) Filed: Aug. 17, 2009

(51) Int. Cl. G06G 7/48

(52) U.S. Cl. 703/6

(57) ABSTRACT

A method and system to conduct multi-dimensional data analysis. A parameter value is applied to a first layer of a multi-dimensional data set. A simulation is conducted to evaluate the effect of the parameter value at the first layer. The effect at the first layer is automatically propagated to a second layer where a further simulation permits visualization of the effect at a different level of granularity as well as the effect of orthogonal data.

### FIELD OF INVENTION

Embodiments of the invention relate to multi-dimensional data analysis. More specifically, embodiments of the invention relate to propagation of simulation effects between various layers of a multi-dimensional data set.

### BACKGROUND

Businesses, both large and small, increasingly rely on simulations to predict the outcome of various alternative business decisions in an effort to avoid the cost negative implications of possible real world trial and error. Business analysts in enterprise companies typically use productivity tools such as spreadsheets equipped with analytical functions to conduct, for example, what-if analysis. While these tools are adequate for performing analysis on flat or non-multi-dimensional data, there is generally no facility for analyzing multi-dimensional data. As used herein, “multi-dimensional data” refers to data which is inherently hierarchical such as time hierarchy in terms of year, month, day, etc. or, for example, location hierarchy such as country, state, city, etc. In the absence of suitable tools, analysis of such hierarchical data tends to be time consuming and labor intensive.

### SUMMARY

A method and system to conduct multi-dimensional data analysis is disclosed. A parameter value is applied to a first layer of a multi-dimensional data set. A simulation is conducted to evaluate the effect of the parameter value at the first layer. The effect at the first layer is automatically propagated to a second layer where a further simulation permits visualization of the effect at a different level of granularity.

### BRIEF DESCRIPTION OF THE DRAWINGS

The invention is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

FIG. 1 is a block diagram of a system for analyzing multi-dimensional data sets in accordance with one embodiment of the invention.

FIG. 2 is a flow diagram of operation of one embodiment of the invention.

FIG. 3 is a flow diagram of operation of one embodiment of the invention.

### DETAILED DESCRIPTION

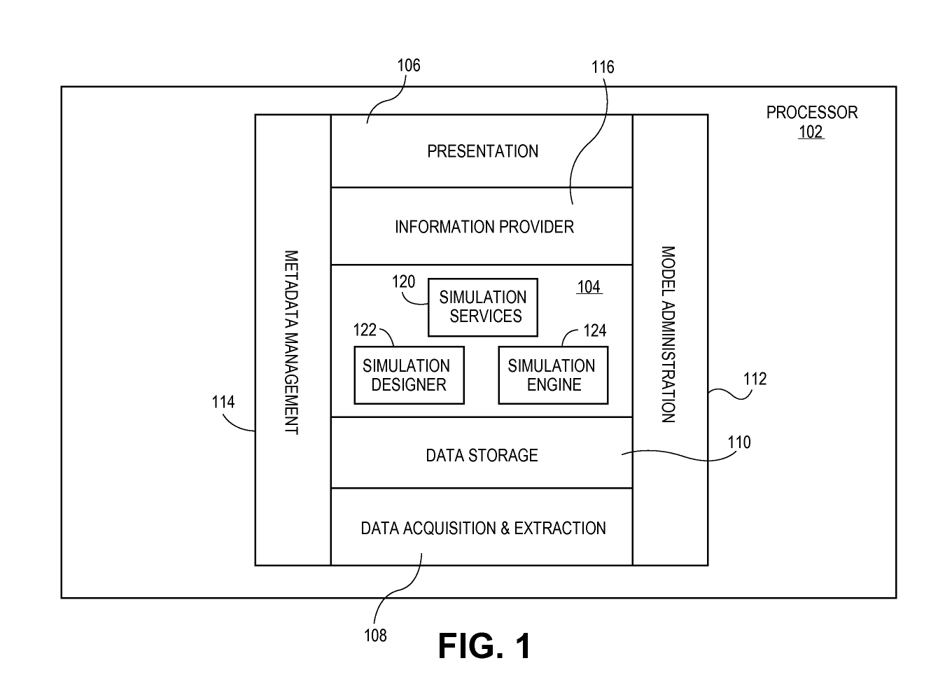

FIG. 1 is a block diagram of a system for analyzing multi-dimensional data sets in accordance with one embodiment of the invention. Processor 102 includes a simulation layer 104 to conduct simulations on a multi-dimensional data set. Multi-dimensional data set may be retained in data storage 110. Typically data storage 110 is pre-populated with the multi-dimensional data set by data acquisition and extraction layer 108 from, for example, data acquired or extracted from remote nodes, or other files that are possible sources of multi-dimensional data. In one embodiment, data acquisition and extraction layer 108 may retrieve multi-dimensional data set from a plurality of e.g., physical sales locations distributed about a geographic area.

Also associated with simulation layer 104 are information provider 116 and presentation layer 106. Presentational layer 106 may include a graphical user interface (GUI) to permit parameter input and visualization of results of simulations from the simulation layer 104. Model administration 112 provides administrative support for analytical models of simulation layer 104. Additionally, metadata management layer 114 provides real time data support to simulation layer 104.

Information provider 116 provides services for distributing information to presentation layer 106. For example, a client program in the presentation layer can use the services to exchange information between the client program and the multidimensional system. In various embodiments, the information may be exchanged using for example a query, an API (application programming interface), a WS (web services), and/or XML/A (extensible markup language for analysis).

Metadata management 114 provides services for storing and retrieving data about business or technical data. These services may include general business rules or semantics, data types, allowable values, etc. In response to a request for the data, the system looks up the data by unique name of the data and returns the information to information provider 116 for processing.

Model administration 112 provides services for managing the design and access control of business models such as information cubes (or multidimensional data sources) and domain-specific business models. In response to a user request, the system either creates or retrieves the definition of a business model for design or execution activities, respectively.

Within simulation layer 104, is a simulation services module 120 which handles user interaction with the presentation layer 106. For example, simulation services module 120 will receive user requests for modeling including, for example, the parameters to be used in connection with a simulation. The simulation layer 104 also includes a simulation designer 122 to permit the creation of simulation models at design time based on commands received from the simulation services module 120. Finally, the simulation layer 104 includes simulation engine 124 that accepts commands from the simulation services module 120 to perform simulations at runtime executing the models created by simulation designer 122 at design time. In one embodiment, simulation engine 124 provides three simulation methods important for use in connection with multi-dimensional data set. Specifically, simulation engine 124 provides drill down simulation, drill up simulation and drill through simulation. Each of these is discussed in greater detail below.

Generally, drill down simulation occurs where parameter values are set for a parent member e.g., in a geographical model, the world, and a simulation is performed at the parent level. Then, drill down from the parent level to a child level e.g., in a geographic context a country level. A simulation is automatically performed at the child level (the country level) and the values and effects of the parametric change at the parent level are inherited to the children. Each child can be viewed as a parent member for subsequent drill down analysis, e.g. to a state or city level until a maximum supported granularity is reached.

How the effect on the parent level is distributed at the child level may be defined in the simulation model at design time. For example, in some embodiments, the effect from the parent level to the child level may be distributed prorata. In other embodiments, it may be distributed based on e.g., square footage of retail space within the sub region. In other cases, it may be distributed on a weighted basis based on average disposable income of the population in the region. The basis for the automatic distribution of the effect may be arbitrarily complex to insure visualization of a particular desired effect. It is noted that the model created for simulation may also be arbitrarily complex and the effect resulting from a parameter change may be multi-factorial.

Simulation engine 124 also automatically conducts drill up simulation. Drill up simulation provides aggregation of the simulation to the parent level. For example, sales changes at the state level may be aggregated to the country level and sales changes by the country level can be aggregated to the world level. The drill up simulation may be conducted recursively until the highest layer of the data set is reached. In some cases, the drill up simulation may be used to evaluate the effect of changes at a single child member to the next level up. For example, the effect on global sales of a 37% increase in sales in Uganda resulting from a promotional effort there. In this example, the increase in sales in Uganda would be aggregated with a zero percent increase from the other constituents at the country level (since the promotional level in Uganda in unlikely to effect sales in other countries).

Additionally, the simulation engine 124 conducts drill through simulations by extending the simulation effect to a wider context orthogonal to the current dimensional hierarchy. In this context, after performing the simulation at the current level, the simulation value is propagated to members external from the data associated with the current member. For example, sales (s) for a given product at a given time for a given store may be associated with external elements (orthogonal data) such that the store's physical size (p) or the store's employment size (e), etc. Here sales is the associator and the store's physical size and employee size are the associated external members. Associations may be established as an expression such as a ratio between the associator and associated data. For example, p/s or e/s. It should be apparent in any change in s to e.g., s′ will result in a change in the corresponding ratio, i.e., p/s′ and e/s′. The process may be repeated for each member of the data set.

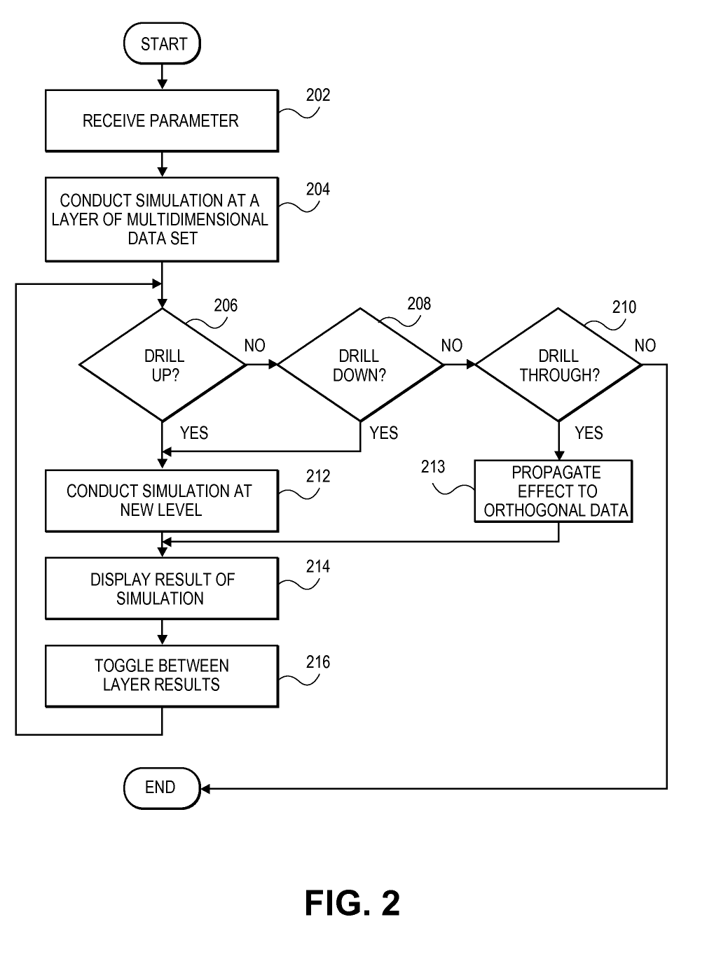

FIG. 2 is a flow diagram of operation of one embodiment of the invention. At block 202, parameter values for which the simulation is to be conducted are received. At block 204, a simulation is conducted at a current layer of a multi-dimensional data set. As indicated above, “multi-dimensional data” set refers to the data set which has an inherent hierarchy and a “layer” of multi-dimensional data set is the data at a particular level of the hierarchy.

At decision block 206, a determination is made if a drill up simulation should be conducted. If no drill up simulation is to be conducted, a determination is made at decision block 208 if drill down simulation is to be conducted. If not, a decision is made at decision block 210 whether a drill through simulation should be conducted. If in the corresponding decision blocks 206, a decision is made to conduct a drill up or drill down simulation, a simulation is conducted at the new level at block 212. If a drill through simulation is desired at decision block 210, the effect is propagated from the current level to orthogonal data associated with, but not a member of, the multi-dimensional data set.

At block 214, the results of the simulation are displayed on, for example, a computer monitor, laptop or other electronic display. At block 216, users permitted to toggle between results at different layers to the various simulation results can be easily visualized on the display. If no further simulation is desired at decision block 210, routine ends. If further drill up or drill down simulation is desired after reviewing the existing results, such alternative level analysis can be conducted recursively.

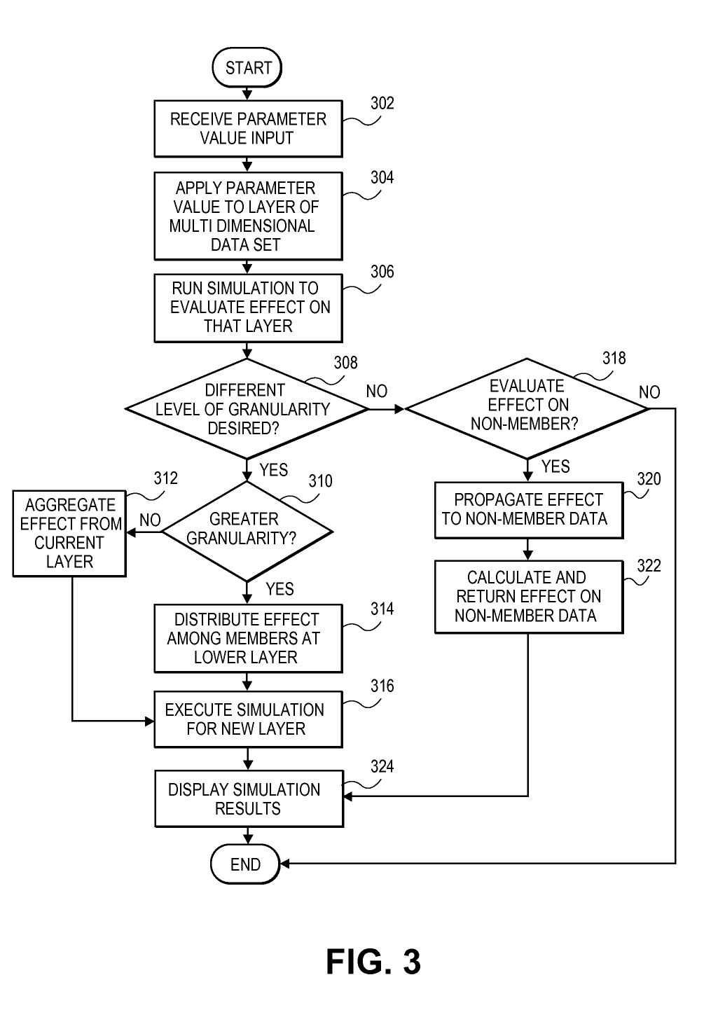

FIG. 3 is a flow diagram of operation of one embodiment of the invention. At block 302, a simulation parameter can put value as received. At block 304, the parameter value is applied to an existing layer of a multi-dimensional data set. At block 306, the simulation is executed to evaluate the effect on that layer of the multi-dimensional data set. At decision block 308, a determination is made at the different level of granularity within the data set is desired. If so, a determination is made at decision block 310 whether the desired level of granularity is greater.

If the desired level of granularity is not greater at block 310, the effects from the current layer aggregated to determine the aggregated effect from the current layer on the next layer up at block 312. Here, higher layer refers to less granular e.g., from state to country or country to world in a geographic context or from day to week, week to month, month to year in a temporal context. At block 316, a simulation is executed at the new layer, and at block 324, result of the simulation are displayed. If at decision block 310 it is desired that a greater level of granularity is desired, the effect on the current layer is distributed among members at a lower layer at block 314, e.g., a layer with greater granularity country to state or year to quarter, for example. At block 316, a simulation is executed at the new layer at block 324 and results of the simulation are displayed.

If no different level of granularity is desired at block 308, a determination is made at block 318 whether it is desired to evaluate the effect on a non-member of the multi-dimensional data set. As discussed above, non-member data refers to orthogonal data associated with member data in the multi-dimensional data set. If it is desired to evaluate the effect on a non-member, the effect on the current members of the current layer is propagated to the non-member data at block 320. At block 322, the effect on a non-member data is calculated and the results are displayed at block 324.

While embodiments of the invention are discussed above in the context of flow diagrams reflecting a particular linear order, this is for convenience only. In some cases, various operations may be performed in a different order than shown or various operations may occur in parallel. It should also be recognized that some operations described with respect to one embodiment may be advantageously incorporated into another embodiment. Such incorporation is expressly contemplated.

Elements of embodiments of the present invention may also be provided as a machine-readable medium for storing the machine-executable instructions. The machine-readable medium may include, but is not limited to, flash memory, optical disks, compact disks read only memory (CD-ROM), digital versatile/video disks (DVD) ROM, random access memory (RAM), erasable programmable read-only memory (EPROM), electrically erasable programmable read-only memory (EEPROM), magnetic or optical cards.

In the foregoing specification, the invention has been described with reference to the specific embodiments thereof. It will, however, be evident that various modifications and changes can be made thereto without departing from the broader spirit and scope of the invention as set forth in the appended claims. The specification and drawings are, accordingly, to be regarded in an illustrative rather than a restrictive sense.

What is claimed is:

1. A method comprising:
applying a parameter value to a first layer of a multi-dimensional data set within a processor;
evaluating an effect of the parameter at the first layer; and
automatically propagating the effect to a second layer to permit visualization of the effect at a different granularity.

2. The method of claim 1 wherein automatically propagating comprises:
aggregating the effect from a plurality of members of the first layer.

3. The method of claim 1 wherein automatically propagating comprises:
distributing the effect from the first layer among a plurality of members at the second layer.

4. The method of claim 1 further comprising:
propagating the effect to a non-member of the multi-dimensional data set.

5. The method of claim 1 further comprising:
displaying a second visualization of the effect at the second layer on an electronic display.

6. The method of claim 5 further comprising:
toggling between a first visualization of the effect at the first layer and the second visualization on the electronic display.

7. A system comprising:
a processor;
a data source;
a presentation layer; and
a simulation layer, the simulation layer to automatically conduct at least one of drill up, drill down and drill through simulation on a multi-dimensional data set from the data source.

8. The system of claim 7 wherein the simulation layer comprises:
a set of simulation services to interpret user interactions; and
a simulation engine to execute simulations at runtime.

9. The system of claim 8 wherein the simulation layer further comprises:
a simulation designer to create analytical models at design time, the analytical models to be used by the simulation engine at runtime.

10. The system of claim 7 wherein the simulation layer automatically propagates an effect of a parameter change between layers of the multi-dimensional data set.

11. The system of claim 7 wherein the simulation layer automatically propagates an effect of a parameter change to external non-member data associated with a member of the multi-dimensional data set.

12. A machine-accessible medium containing instructions that when executed cause a machine to:
apply a parameter value to a first layer of a multi-dimensional data set within a processor;
evaluate an effect of the parameter at the first layer; and
automatically propagate the effect to a second layer to permit visualization of the effect at a different granularity.

13. The machine-accessible medium of claim 12 wherein the instruction causing the machine to propagate cause the machine to:
aggregate the effect from a plurality of members of the first layer.

14. The machine-accessible medium of claim 12 wherein the instruction causing the machine to propagate cause the machine to:
distribute the effect from the first layer among a plurality of members at the second layer.

15. The machine-accessible medium of claim 12 wherein the instruction cause the machine to:
display a second visualization of the effect at the second layer on electronic display.

16. The machine-accessible medium of claim 15 wherein instruction cause the machine to:
toggle between a first visualization of the effect at the first layer and the second visualization on the electronic display.

17. The machine-accessible medium of claim 12 wherein the instruction cause the machine to:
propagate the effect to a non-member of the multi-dimensional data set.
